(19) United States
(12) Patent Application Publication
(10) Pub. No.: US 2023/0023948 A1
(43) Pub. Date: Jan. 26, 2023

(54) VEGETABLE-BASED FOOD PRODUCTS AND METHODS OF MANUFACTURE THEREOF

(71) Applicant: OUTSTANDING FOODS, INC., Los Angeles, CA (US)

(72) Inventors: David K. ANDERSON, Moorpark, CA (US); Henry Zollinger MILLER, Woodland, CA (US)

(21) Appl. No.: 17/787,912

(22) PCT Filed: Dec. 18, 2020
(86) PCT No.: PCT/US2020/066257

§ 371 Date: Jun. 21, 2022

Related U.S. Application Data
(60) Provisional application No. 62/952,061, filed on Dec. 20, 2019.
(60) Provisional application No. 63/090,694, filed on Oct. 12, 2020.

(51) Int. Cl. A23L 7/17; A23L 11/00; A23L 7/10; A23L 33/155; A23L 33/16; A23L 33/185; A23P 30/20

(52) U.S. Cl. CPC A23L 7/17; A23L 11/05; A23L 7/101; A23L 33/155; A23L 33/16; A23L 33/185; A23P 30/20; A23V 2002/00

(57) ABSTRACT

Extruded vegetable-based food products and methods for their manufacture are described herein. In some variations, the extruded vegetable-based food products provide healthy snack options, which may be savory or sweet. In other variations, the extruded vegetable-based food products include sufficient complete protein along with other nutrients to provide healthy meal replacement options.

### CROSS REFERENCE TO RELATED APPLICATIONS

This patent application claims priority to U.S. Provisional Patent Application No. 62/952,061, filed on Dec. 20, 2019, titled “VEGETABLE-BASED FOOD PRODUCTS AND METHODS OF MANUFACTURE THEREOF,” and U.S. Provisional Patent Application No. 63/090,694, filed Oct. 12, 2020, titled “VEGETABLE-BASED FOOD PRODUCTS AND METHODS OF MANUFACTURE THEREOF,” each of which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Snack foods and meal replacement foods including more healthful ingredients and methods of manufacture thereof, which do not degrade the nutritional value of such foods are described. Particularly, nutritionally complete vegetable-based protein is included within the snack foods and meal replacement foods to answer the change in marketplace demand for foods to be consumed “on the go” which provide more healthful alternatives to traditional snack foods such as potato chips, and the like.

### BACKGROUND

Snack foods and other convenience foods are experiencing a change in demand from consumers to provide improved protein content in convenient and healthful formulations. There is a need for healthier, e.g., higher-protein, higher nutritional value, snack foods, and particularly palatable snack-foods in a convenient and desirable form that are reliably and easily manufactured. Described herein are snack foods, and/or meal replacement foods, which can satisfy contemporary consumer demands, and methods of producing them.

### SUMMARY OF THE DISCLOSURE

The present invention relates to more healthful snack and/or meal replacement food product ingredients which can be produced via methods which do not degrade the nutritional value of such foods. Snack foods and/or meal replacement foods that contain significant amounts of protein are demanded in the marketplace, and producing these products from “natural” materials, e.g., the ingredients list contain predominantly only recognizable base ingredients such as pulses or grains, and commonly known nutrients such as vitamins, and the like is attractive. In some variations, these products may be produced from organically grown base ingredients. In particular, described herein are “puffed” snack foods that are high-protein and/or meal replacement foods.

Additionally, consumers may want snack foods and/or replacement meal foods that are sourced only from vegetable-based ingredients and not sourced from animal-based products. Further, an increasing number of consumers may seek snack food and/or meal replacement products that are gluten-free. Some consumers want snack foods and/or meal replacement foods that require no preparation at all, are easily and handily snackable, requiring no diversion from other activities to prepare and eat. They further may want pre-packaged snacks and meal replacements with pre-portioned amounts providing a reasonably healthful diet including proteins and, optionally, other nutrients. Desirably these snacks and meal replacement products include proportional amounts of essential nutrients such as vitamins and minerals.

Herein are described snack foods and/or meal replacement foods satisfying all of these contemporary consumer demands, and methods of producing them. Particularly, described herein are extruded vegetable-based food products and extruded vegetable-based meal replacements that provide healthful, high protein snacks and meal replacements in an aerated bite-sized form.

Accordingly, in a first aspect, an extruded vegetable-based food product is provided, including: a solid vegetable composition comprising a leguminous protein isolate; leguminous grits; and rice grains; vegetable oil; flavorings; and water, wherein the extruded vegetable-based food product has a density from 50 g/L to 90 g/L (and in particular, a density of less than 100 g/L, less than 90 g/L, less than 85 g/L, etc.). In addition, the puffed vegetable-based food products described herein may have one or more preferably more than one grain isolate, such as both Pea Protein Isolate and Brown Rice Protein Isolate. Other types of plant-based protein isolates may be used, including one or more of: seed proteins, potato protein, vegetable proteins, fungi proteins, etc.

In some variations, the water may make up 0.5% to 2% of the weight of the extruded vegetable food product. The leguminous protein isolate may make up 20% to 30% of the solid vegetable composition w/w. In some variations, the leguminous grits may make up 15% to 25% of the solid vegetable composition w/w. In some variations, the rice grains of the solid vegetable composition may make up 40 to 60% of the solid vegetable composition w/w.

In some variations, the leguminous protein isolate may be pea protein isolate. In some variations, the leguminous grits may be pea grits. The pea grits may be a coarsely ground pea flour, and may further be a stone-ground pea flour. In some variations, the rice grains may be white rice. The white rice may be pulverized, e.g., coarsely ground such as a rice meal. The rice meal may be stone ground. In some variations, the vegetable oil may include sunflower oil.

In some variations, the solid vegetable composition may make up from 65 to 80% of the extruded vegetable food product w/w. In some variations, the vegetable oil may make up from 15% to 20% of the extruded vegetable food product w/w. In some variations, the flavorings, e.g., seasonings, may make up from 5% to 15% of the extruded vegetable product w/w. The seasoning may also include protein. In some embodiments, the flavorings may be vegetable-based flavorings. In some embodiments, the flavorings may be non-animal derived flavorings.

In another aspect, an extruded vegetable-based meal replacement is provided including: a solid vegetable composition comprising a leguminous protein isolate (e.g., pea protein isolate); leguminous grits (e.g., yellow pea flour); and rice grains (e.g., brown rice protein isolate); vegetable oil; flavorings; and water, wherein the extruded vegetable-based meal replacement has a density from 50 g/L to 80 g/L and further wherein the extruded vegetable-based meal replacement comprises at least 7 g protein per ounce. As described in greater detail herein, the use of brown rice protein isolate in combination with leguminous protein isolate, calcium carbonate, encapsulated vegetable vitamins, and within the described ranges (e.g., brown rice protein isolate in the extrusion mixture of between 2.5%-20%) was surprisingly found to be important for extrusion to achieve a density of between 50 g/L and 90 g/L, as required for a viable product.

In some variations, the vegetable-based meal replacement may further include a nutrient composition, where the nutrient composition includes vitamins and minerals. The vitamins may include one or more of Vitamin A, Vitamin B, Vitamin B12, Vitamin C, Vitamin D, and Vitamin K, in any combination. For example, the product described herein may include vitamins and minerals having a daily value (DV) of at least 30% (per 3 oz. serving) of: Vitamin A, Vitamin B6, Vitamin B12, Vitamin C, Vitamin D, Vitamin E, Vitamin K, Thiamin, Riboflavin, Niacin, Calcium, Iron, Iodine, Zinc, Selenium, Copper, Manganese, Chromium,

Molybdenum. In some embodiments, at least one of the vitamins may include an anti-oxidant vitamin. In some variations, the minerals may include one or more of Calcium or Iron. In some variations, the quantity of the nutrient composition may include >25% (e.g., 25%-50%) of a daily recommended amount per three-ounce portion of the extruded vegetable-based meal replacement. In some variations, the vegetable-based meal replacement may further include omega-3 fatty acids.

In some variations, the vegetable-based meal replacement, water may make up 0.5% to 2.0% or 0.5% to 1.5% of the weight of the extruded vegetable food product.

In some variations, the leguminous protein isolate may make up 20% to 30% of the solid vegetable composition w/w. In some variations, the leguminous grits may make up 15% to 25% of the solid vegetable composition w/w. In some variations, the rice grains of the solid vegetable composition may make up 40 to 60% of the solid vegetable composition w/w.

In some variations, the leguminous protein isolate may be pea protein isolate. In some variations, the leguminous grits may be pea grits. The pea grits may be a coarsely ground pea flour, and may further be a stone-ground pea flour. In some variations, the rice grains may be white rice. The white rice may be pulverized, e.g., coarsely ground such as a rice meal. The rice meal may be stone ground. In some variations, the vegetable oil may include sunflower oil.

In some variations, the solid vegetable composition may make up from 65 to 80% of the extruded vegetable-based meal replacement w/w. In some variations, the vegetable oil may make up from 15% to 20% of the extruded vegetable-based meal replacement w/w. In some variations, the flavorings, e.g., seasonings, may make up from 5% to 15% of the extruded vegetable-based meal replacement w/w. In some embodiments, the flavorings may include vegetable-based flavorings. In some embodiments, the flavorings may include non-animal derived flavorings. In some variations, the nutrients may include non-animal derived nutrients. In some embodiments, the omega-3 fatty acids may include non-animal derived omega-3 fatty acids.

In another aspect, a method of producing an extruded vegetable-based food product is provided, including: combining a solid vegetable composition comprising a leguminous protein isolate; leguminous grits and rice grains with water to form a dough; extruding the dough under heat to form an extruded vegetable-based aerated bite-sized form; drying the extruded vegetable-based aerated bite-sized form, whereby the dried extruded vegetable-based aerated bite-sized form comprises less than 2% water content; tumbling the dried extruded vegetable-based aerated form to produce the extruded vegetable-based food product having a density from 50 g/L to 80 g/L. In some variations, the ratio of the solid vegetable composition to the water in the dough may be from 80:20 to 85:15.

In some variations, extruding the dough under heat may include extruding the dough at a temperature from 300 degrees F. to 350 degrees F. In some embodiments, the dough may be extruded at a temperature of 325 degrees F. The extruded vegetable-based aerated bite-sized form may be a crisp, a puff, a shape mimicking a piece of a meat product, a sphere, or an irregular polygonal shape. In some variations, drying the extruded vegetable-based aerated bite-sized form may be performed at a temperature from 100 degrees F. to 350 degrees F. In some variations, tumbling may further include applying a vegetable-based oil to the dried extruded vegetable-based aerated form before tumbling the dried extruded vegetable-based aerated form. In some variations, the vegetable-based oil may be sunflower oil.

In some variations, tumbling may further include applying flavorings, e.g., seasonings, after tumbling the dried extruded vegetable-based aerated form. In some embodiments, the flavorings may include vegetable-based flavors. In some embodiments, the flavorings may be savory, salty, or sweet. In some embodiments, the flavorings may include at least one spice. In some embodiments, the flavorings may produce a flavor imitating a meat product. In some variations, tumbling may be performed at a temperature elevated above an ambient temperature. In some variations, the extruded vegetable-based food product may have a water content from 0.5% to 2.0% w/w.

In some variations, the leguminous protein isolate may make up 20% to 30% of the solid vegetable composition w/w. In some variations, the leguminous grits may make up 15% to 25% of the solid vegetable composition w/w. In some variations, the rice grains of the solid vegetable composition may make up 40 to 60% of the solid vegetable composition w/w.

In some variations, the leguminous protein isolate may be pea protein isolate. The leguminous grits may be pea grits. In some variations, the rice grains may be white rice. In some variations, the rice grains may be white rice. The white rice may be pulverized, e.g., coarsely ground such as a rice meal. The rice meal may be stone ground. In some variations, the vegetable oil may include sunflower oil.

In some variations, the extruded vegetable-based food product may include at least 7 g protein per ounce, thereby providing an extruded vegetable-based meal replacement, optionally, when a three ounce portion is consumed. In some variations, the dough may further include a nutrient composition, where the nutrient composition includes vitamins and minerals.

The vitamins may include one or more of Vitamin A, Vitamin B6, Vitamin B12, Vitamin C, Vitamin D, Vitamin E, Vitamin K, Thiamin, Riboflavin, Niacin, Calcium, Iron, Iodine, Zinc, Selenium, Copper, Manganese, Chromium, and Molybdenum, in any combination. In some embodiments, at least one of the vitamins may include an anti-oxidant vitamin. In some embodiments, the minerals may include one or more of Calcium or Iron. In some embodiments, the quantity of the nutrient composition may include 25-35% of a daily recommended amount per three-ounce portion of the extruded vegetable-based meal replacement.

In some variations, tumbling may further include applying omega-3 fatty acids.

In some embodiments, the extruded vegetable-based meal replacement may include a puff shape.

For example, described herein are extruded vegetable-based meal replacement compositions comprising: a plurality of puffed cylindrical shapes comprising: 8%-15% of a leguminous protein isolate; 4%-10% of a leguminous grits; 35-50% of a white rice meal; 2-13% of a brown rice isolate; 0.5%-1.5% of a calcium carbonate; and an encapsulated vitamin extract; wherein the puffed cylindrical shapes have a density from 50 g/L to 90 g/L, an even outer surface texture, and further wherein the extruded vegetable-based meal replacement composition comprises at least 7 g protein per ounce. The puffed cylindrical shapes may be substantially free of cracks. The plurality of puffed cylindrical shapes may have a narrow size distribution. For example the puffed cylindrical shapes may be curls or noodle shapes, and 80% or more of the shapes (e.g., 85% or more, 90% or more 95% or more, etc.) may have a length that is within +/−20% (e.g., +/−18%, +/−15%, +/−12%, +/−10%, +/−8%, +/−5%, etc.) of each other. The puffed cylindrical shapes may be substantially uniform in diameter, for example, about 80% or more of the shapes (e.g., 85% or more, 90% or more 95% or more, etc.) may have a diameter that is within +/−10% (e.g., +/−9%, +/−8%, +/−7%, +/−6%, +/−5%, etc.) of each other.

As discussed in greater detail herein, the use of brown rice protein, and in particular the specified ranges of brown rice protein (e.g., between 2.5%-20%), in combination with the specific range of calcium carbonate (e.g., between 0.75%-2.0% in the mix) was surprisingly found to be critical for the formation of puffed bodies having reasonably uniform dimensions that, and regular (e.g., even-textured) outer surfaces that are free (or substantially free) of cracking. This may be particularly true given the high levels of protein in the extruded vegetable-based product. Other vegetable protein sources (other than brown rice protein isolate) did not work. The extruded vegetable-based products described herein required both the presence of calcium carbonate and brown rice protein isolate within the specified range in order to allow extrusion into event-textured, uniformly sized puffs that were substantially free of cracking and having a density from 50 g/L to 90 g/L, as needed.

Any of these products may include vegetable oil and seasonings, such as a vegetable-based flavoring that is substantially free of animal byproducts. In some examples, the product includes an encapsulated vitamin extract comprises one or more of Vitamin A, Vitamin B, Vitamin B12, Vitamin C, Vitamin D, Vitamin K, in any combination. The encapsulated vitamin extract may comprise an antioxidant vitamin.

The extruded vegetable-based meal replacement composition may include 25%-30% of a daily recommended amount per three-ounce portion of the extruded vegetable-based meal replacement composition. The puffed cylindrical shape may have 0.5% to 1.5% water by weight of the extruded vegetable-based meal replacement composition.

The leguminous protein isolate may include 10%-13% w/w of the extruded vegetable-based meal replacement composition. In some examples, the leguminous grits comprises 5%-9% w/w of the extruded vegetable-based meal replacement composition. The white rice meal may comprise between 37% to 47% w/w of the extruded vegetable-based meal replacement composition. In some examples the leguminous protein isolate is pea protein isolate. The leguminous grits may comprise pea grits.

For example, an extruded vegetable-based meal replacement composition may include: a plurality of puffed bodies having an even outer surface texture, the puffed bodies comprising: about 8%-15% of a leguminous protein isolate; about 4%-10% of a leguminous grits; about 35-50% of a white rice meal; about 2-13% of a brown rice isolate; about 0.5%-1.5% of a calcium carbonate; and an encapsulated vitamin extract; wherein the puffed bodies have a density from about 50 g/L to 90 g/L, are substantially free of cracks, and further wherein the extruded vegetable-based meal replacement composition comprises at least about 7 g protein per ounce.

An extruded vegetable-based food product may include a puffed composition that is substantially free of cracks and has an even surface texture, the puffed composition comprising a leguminous protein isolate; a leguminous grits; a rice grain; between about 2%-13% of a brown rice protein isolate; and between about 0.5%-1.5% of a calcium carbonate; wherein the puffed composition has a density from 50 g/L to 90 g/L and has about 6 g or more of protein per 3 ounce serving.

The rice protein isolate may comprise between about 2.5 and 20% of the puffed composition. Water may comprise between about 0.5% to 5% of by weight of the extruded vegetable-based food product. The leguminous protein isolate may comprise about 10% to 25% of the puffed composition w/w. The leguminous grits may comprise about 5% to 20% of the puffed composition w/w. The puffed composition may comprise about 50 to 75% of the puffed composition w/w. The leguminous protein isolate may be pea protein isolate. The leguminous grits may comprise pea grits. The rice grains may comprise white rice. The white rice may be pulverized.

The puffed composition may include a vegetable oil (e.g., sunflower oil), which may be between 15% to 20% w/w of the extruded vegetable-based food product. The extruded vegetable-based food product may also include between about 5% to 15% of flavorings, such as vegetable-based flavorings.

Also described herein are methods of manufacturing a vegetable-based meal replacement composition, the method comprising: forming a mixture of: 10%-25% leguminous protein isolate; 5%-20% leguminous grits; 50-75% white rice meal, 2.5-20% brown rice isolate, 0.75%-2.0% calcium carbonate in water; and extruding the mixture to form a plurality of puffed bodies having a density from 50 g/L to 90 g/L and an even outer surface texture that is substantially free of cracking, wherein the extruded vegetable-based meal replacement composition comprises at least 7 g protein per ounce. Extruding the puffed bodies may comprise extruding cylindrical shapes (or any other shapes, e.g., round square, triangular, etc.). Forming the mixture may include adding 0.1%4% of an encapsulated vitamin blend. Any of these methods may include seasoning the plurality of puffed bodies. The method may include using between 12-20% of pea protein isolate as the leguminous protein isolate, and/or using between 7%-12% of yellow pea flour as the leguminous grits, and/or using between 8%-12% of brown rice protein isolate.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 illustrates an image showing an extruded vegetable-based meal replacement composition as described herein. In FIG. 1 the composition is shown as a plurality of puffed cylindrical shapes the each have a density from 50 g/L to 90 g/L, are substantially uniform, and have an even outer surface texture that is substantially free of cracking.

FIGS. 2A-2E illustrate examples of extruded vegetable-based compositions that are formed either without including brown rice protein or without the brown rice protein and calcium carbonate within the ranges specified herein, resulting in extruded vegetable-based compositions that are irregularly shaped, with rough outer surfaces and a substantial amount of cracking and/or splitting.

FIGS. 3A-3B show tables illustrating variations of the extruded vegetable-based compositions that have been scored based on their morphology (e.g., regularity of shape), surface texture (smoothness), and cracking and/or splitting. Formulation components, including the use of alternative formulation components, and alternative percentages are shown. FIG. 3B continues the listing shown in FIG. 3A.

FIG. 4 illustrates one example of a method of manufacturing the extruded vegetable-based compositions described herein.

### DETAILED DESCRIPTION

Described herein are extruded vegetable-based meal replacement composition compositions. These compositions may be formed into puffed shapes, including (but not limited to) puffed cylindrical shapes. The vegetable-based meal replacement compositions described herein may include a high level of protein (e.g., at least 6 g or protein per ounce, at least 7 g or protein per ounce, etc.) as well as additional nutrients (e.g. vitamins and minerals), by including a high percentage of vegetable proteins from vegetable grains and flours. However, as described in greater detail herein, forming a puffed vegetable-based meal replacement composition with these parameters that may be extruded cleanly and uniformly, to form an even outer surface texture that is substantially free of splitting and/or cracking, and having a density of between about 50 g/L to 90 g/L is particularly challenging. The novel methods and compositions described herein identify a specific range of one particular flour, brown rice protein, which is critical for extruding the puffed vegetable-based meal replacement compositions as described herein. For example, these compositions may include a leguminous protein isolate (e.g., pea protein isolate, 8%-15%), a leguminous grits (e.g., yellow pea flour, 4%-10%), and a white rice meal (e.g., 35-50%), in addition to the brown rice isolate (e.g., 2-13% in the seasoned product) and a calcium carbonate (e.g., 0.5-1.5% in the final product). The final product may also include an encapsulated vitamin extract.

The puffed product may have a substantially even outer surface texture. As used herein a substantially even outer surface texture may refer to an outer surface texture that is substantially free of splitting (e.g., longitudinal splitting), long the long axis of the puffed body (e.g., extending 30% or more of the length of the puffed body. The surface texture of the puffed product may be regular; as used herein an even outer texture does not mean smooth but refers to the regularity of the surface. The outer surface may be substantially free of cracks (including splitting, as mentioned above). “Substantially” may refer to completely or mostly (e.g., greater than about 85%, greater than about 90%, greater than about 92%, greater than about 95%, etc.).

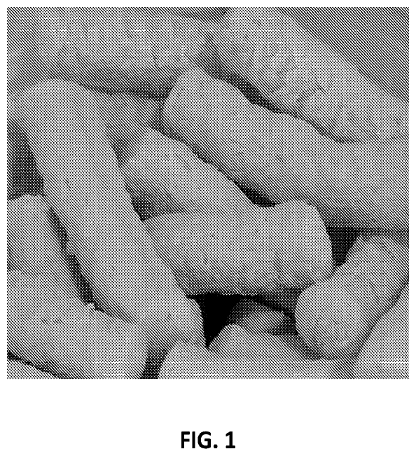

For example, FIG. 1 illustrates an example of a vegetable-based meal replacement composition, showing a plurality of puffed cylindrical shapes. In FIG. 1, the shapes have an even outer surface texture that is regular and substantially free of cracks. A crack typically refers to a fissure opening into the body that extends into the body by more than about 5% (e.g., more than about 10%, more than about 15%, etc.) of the diameter of the body. In FIG. 1, the puffed bodies are formed as cylindrical curls that have a substantially uniform diameter and length. Thus, in this example, the plurality of puffed cylindrical shapes may have a narrow size distribution. For example 80% or more of the cylindrical shapes (e.g., 85% or more, 90% or more 95% or more, etc.) may have a length that is within +/−20% (e.g., +/−18%, +/−15%, +/−12%, +/−10%, +/−8%, +/−5%, etc.) of each other. The puffed cylindrical shapes may be substantially uniform in diameter, for example, about 80% or more of the shapes (e.g., 85% or more, 90% or more 95% or more, etc.) may have a diameter that is within +/−10% (e.g., +/−9%, +/−8%, +/−7%, +/−6%, +/−5%, etc.) of each other.

This example of an extruded vegetable-based meal replacement composition also has a density from 50 g/L to 90 g/L, and 7 g protein or more per ounce. These puffs may be flavored and may provide a pleasant mouth feel. “Mouth feel” as used herein refers to the overall appeal of a food product, which stems from the combination of characteristics such as aroma, moistness, chewiness, bite force, degradation, and fattiness that together provide a satisfactory sensory experience.

“Protein” as used herein refers to a polymeric form of amino acids of any length, which can include coded and non-coded amino acids, chemically or biochemically modified or derivatized amino acids, and polypeptides having modified peptide backbones.

Snack foods and/or meal replacement foods are experiencing a change in demand from consumers. Consumers wish for these products to contain more healthful ingredients and to be produced via methods which do not degrade the nutritional value of such foods. Frying or other high heat manufacturing methods can destroy heat sensitive health-promoting ingredients such as vitamins; impart off-flavors; and add excess fats or oils to the food.

Consumers may demand snack foods and/or meal replacement foods that contain significant amounts of protein, and may also demand that these products be made from “natural” materials, e.g., the ingredients list contain predominantly only recognizable base ingredients such as pulses or grains, and commonly known nutrients such as vitamins, and the like. Consumers may, in some variations, demand that these products be sourced from organically grown base ingredients.

Additionally, consumers may want snack foods and/or replacement meal foods that are sourced only from vegetable-based ingredients and not sourced from animal-based products. In some instances, sourcing materials from vegetable-based ingredients, even if the snack food and/or meal replacement food may have an odor or flavor associated with selected animal-based products, may be desirable, e.g., for consumers who do consume animal-based foods but may prefer to consume a vegetable-based snack food which may impart savory flavors and a satisfying crisp, crunchy or crackly bite. Further, an increasing number of consumers may seek snack food and/or meal replacement products that are gluten-free.

In addition, another set of consumers may not be interested in preparing foods for their meals, and wish to obtain their daily nutritional requirements without preparing even the simplest of foods, e.g., cereal with milk. These consumers want snack foods and/or meal replacement foods that require no preparation at all, are easily and handily snackable, requiring no diversion from other activities to prepare and eat. They further may want pre-packaged snacks and meal replacements with pre-portioned amounts providing a reasonably healthful diet including proteins and, optionally, other nutrients.

Additionally, the snack foods and/or meal replacement can provide additional benefits to various sub-groups of consumers not typically associated with the snack food category. For example, vegetarian diets are associated with the many health benefits that a higher dietary content of fiber, folic acid, vitamins C and E, potassium, magnesium, many phytochemicals, as well as a lower dietary content of sugar, cholesterol, and hydrogenated or trans fats can provide. Vegan diets contain even less saturated fat and cholesterol and even more dietary fiber. However, vegetarian and vegan diets are also associated with an increased risk of certain nutritional deficiencies. As a result, vegetarians and vegans are advised to supplement their plant-based diets with nutrients that are not readily available from plant sources but are necessary to meet physiological requirements, such as vitamins B-12 and D, calcium, zinc, iron, and long-chain n-3 (omega-3) fatty acids. They are also advised to ensure adequate protein intake, which can be difficult when following a vegan diet.

Fortified foods and supplements are sold widely, and are also used by many athletes and non-vegetarians/-vegans who are concerned with eating a well-balanced, nutrient-dense diet to enhance their physical and mental performance. These fortified foods and supplements often do not provide satisfying snack products and also may not provide convenient replacement food products including more complete nutrition.

Herein are described snack foods and/or meal replacement foods satisfying all of these contemporary consumer demands, and methods of producing them. Particularly, described herein are extruded vegetable-based food products and extruded vegetable-based meal replacements that provide healthful, high protein snacks and meal replacements in an aerated bite-sized form. The extruded aerated bite-sized form yields a satisfying bite and mouthfeel when eaten for consumers desiring a fun snack and/or meal replacement which is a healthful option.

Accordingly, an extruded vegetable-based food product and/or extruded vegetable-based meal replacement is provided, including a solid vegetable composition which includes a leguminous protein isolate; leguminous grits; and rice grains; vegetable oil; flavorings; and water. The extruded vegetable-based food product is aerated upon extrusion to incorporate air within the structure of the extruded form. Therefore, the extruded vegetable-based food product, e.g. snack, is light compared to its volume, and has a density from about 50 g/L, about 55 g/L, about 60 g/L, about 65 g/L, about 70 g/L, about 75 g/L, or about 80 g/L, or any range of values of density therebetween. The density may alternatively be stated in terms of milligrams/cubic centimeters, i.e., from about 50 mg/cc, about 55 mg/ccL, about 60 mg/cc, about 65 mg/cc, about 70 mg/cc, about 75 mg/cc, or about 80 mg/cc, or any range of values of density therebetween. The extruded vegetable-based food product may have a final water content of about wherein the water makes up about 0.5% w/w, about 1.0% w/w, about 1.5% w/w, about 2% w/w, or any range of values of water content therebetween of the extruded vegetable-based food product and/or extruded vegetable-based meal replacement.

The leguminous protein isolate of the solid vegetable composition is protein isolated from the fruit or seed of a plant in the family Fabaceae, e.g., a pulse, such as beans, peas, chickpeas, lentils, soybeans, peanuts, or tamarind. In some variations, the leguminous protein isolate is a yellow pea protein isolate which may be extracted from yellow peas to contain more than 70%, more than 80% or more than 90% of protein w/w. Yellow pea protein isolate is particularly useful for the extruded vegetable-based food products and meal replacements described herein, as it is a complete protein and includes all nine of the essential amino acids. Yellow pea protein isolate is also low in carbohydrates, providing 24 grams of protein along with only 1 gram of carbohydrate in 33 grams of the protein isolate. In some variations, the leguminous protein isolate may make up about 15% w/w, about 16% w/w, about 17% w/w, about 18% w/w, about 19% w/w, about 20% w/w, about 21% w/w, about 22% w/w, about 23% w/w, about 24% w/w, about 25% w/w, about 27% w/w, about 29% w/w, about 30% w/w, or any range of values of leguminous protein isolate content therebetween of the solid vegetable composition. As will be described in greater detail here, these compositions may also include Brown Rice Protein Isolate, which has been found to be particularly helpful in achieving the high-protein puffed snack products described herein having a density within the specified range of between 50 and 90 g/L.

The leguminous grits of the solid vegetable composition may similarly be the fruit or seed of a plant in the family Fabaceae. In particular, yellow pea grits may be useful for the extruded vegetable-based food products and/or meal replacements. Yellow pea grits, as mentioned above provide complete amino acids, and may be obtained as a coarsely ground flour, which may optionally be stone-ground yellow pea grits. The leguminous grits may form about 12% w/w, about 13% w/w, about 14% w/w, about 15% w/w, about 16% w/w, about 17% w/w, about 18% w/w, about 19% w/w, about 20% w/w, about 21% w/w, about 22% w/w, about 23% w/w, about 24% w/w, about 25% w/w, or any range of values of leguminous grits content therebetween of the solid vegetable composition.

The rice grains of the solid vegetable composition may be white rice grains. Further the white rice grains may be pulverized, e.g., ground. In some variations, the white rice grains are provided as a coarsely ground rice meal or flour, which may be a stone-ground coarsely ground rice meal or flour. The white rice grains are typically not provided as a finely ground rice flour. The white rice grains may form about comprises about 38% w/w, about 40% w/w, about 42% w/w, about 45% w/w, about 47% w/w, about 50% w/w, about 52% w/w, about 55% w/w, about 57% w/w, about 59% w/w, about 60% w/w, about 63% w/w, about 65% w/w, 40 to 65% w/w, or any range of values of rice grains content therebetween of the solid vegetable composition.

The solid vegetable composition may form from about 60% w/w, about 62% w/w, about 64% w/w, about 66% w/w, about 68% w/w, about 70% w/w, about 72% w/w, about 74% w/w, about 76% w/w, about 78% w/w, about 80% w/w, about 82% w/w, or any range of values of the solid vegetable composition content therebetween of the extruded vegetable-based food product and/or extruded vegetable-based meal replacement.

The vegetable oil of the extruded vegetable-based food product and/or extruded vegetable-based meal replacement may be apricot kernel oil, avocado oil, baobab oil, calendula oil, canola oil, corn oil, cottonseed oil, evening primrose oil, grape oil, grape seed oil, hazelnut oil, jojoba oil, linseed oil, macadamia oil, natural oils, neem oil, non-hydrogenated oils, olive oil, palm oil, partially hydrogenated oils, peanut oil, rapeseed oil, safflower oil, sesame oil, soybean oil, or sunflower oil. In some variations, the vegetable oil may be sunflower oil.

The vegetable oil may form from about 12% w/w, about 13% w/w, about 14% w/w, about 15% w/w, about 16% w/w, about 17% w/w, about 18% w/w, about 19% w/w, about 20% w/w, or any range of values of the vegetable oil content therebetween of the extruded vegetable-based food product and/or extruded vegetable-based meal replacement.

The flavorings of the extruded vegetable-based food product and/or extruded vegetable-based meal replacement may be vegetable-based flavorings. In some variations, the flavorings may be non-animal derived flavorings. In some other variations, the flavorings may be derived from animal-based products. Further examples of flavorings may include but are not limited to flavor enhancers and flavoring agents (e.g., 5′-ribonucleotide salts, glumatic acid salts, glycine salts, guanylic acid salts, hydrolyzed proteins, hydrolyzed vegetable proteins, insomniac acid salts, monosodium glutamate, sodium chloride, galacto-oligosaccharides, sorbitol, animal meat flavor, animal meat oil, artificial flavoring agents, aspartamine, fumarate, garlic flavor, herb flavor, malate, natural flavoring agents, natural smoke extract, natural smoke solution, onion flavor, shiitake extract, spice extract, spice oil, sugars, yeast extract). The flavorings may form from about 5% w/w to about 15% w/w (e.g., about 6% w/w, about 7% w/w, about 8% w/w, about 9% w/w, about 10% w/w, about 11% w/w, about 12% w/w, about 13% w/w, about 14% w/w, etc.) or any range of values of the vegetable oil content therebetween of the extruded vegetable-based food product and/or extruded vegetable-based meal replacement.

In some variations, an extruded vegetable-based meal replacement is provided, and it may have any of the solid vegetable compositions, water content, density, vegetable oil, flavorings, and final composition percentages as described above, in any suitable combination. However, the extruded vegetable-based meal replacement may include at least 7 grams protein per ounce, in order to provide sufficient protein content for a three ounce portion to provide a single meal replacement. In various embodiments, about 10%, about 20%, about 30%, about 40%, about 50%, about 60%, about 70%, about 80%, about 90%, about 100% of the U.S. Food and Drug Administration (FDA) recommended daily intake value for protein, or any range of values therebetween for the percentage of FDA recommended daily intake for protein may be provided in the extruded vegetable-based meal replacement. The protein content of a food product can be determined by a variety of methods, including but not limited to Association of Official Agricultural Chemists (AOAC) International reference methods AOAC 990.03 and AOAC 992.15.

In some variations, the extruded vegetable-based meal replacement may further include a nutrient composition, wherein the nutrient composition includes vitamins and minerals. The vitamins may include one or more of Vitamin A, Vitamin B6, Vitamin B12, Vitamin C, Vitamin D, Vitamin E, Vitamin K, Thiamin, Riboflavin, Niacin, Calcium, Iron, Iodine, Zinc, Selenium, Copper, Manganese, Chromium, Molybdenum, in any combination. In some variations, the nutrient composition may include at least one vitamin that is an anti-oxidant vitamin, such as Vitamin A, Vitamin C and/or Vitamin E. In some variations, the nutrient composition may include minerals including calcium and/or iron. In some variations, the quantity of the nutrient composition included within the extruded vegetable-based meal replacement may provide about 10% or more, about 15% or more, about 20% or more, about 25% or more, or preferably about 30% or more of a daily FDA recommended amount per three ounce portion of the extruded vegetable-based meal replacement. In some variations, the nutrient composition may include non-animal derived nutrient ingredients. However, in other embodiments, synthesized and/or extracted vitamins and minerals may alternatively be incorporated into the nutrient composition, and thereby into the extruded vegetable-based replacement meal products.

In some embodiments, the extruded vegetable-based snack foods, e.g., products, and/or the extruded vegetable-based meal replacements may include antioxidants at a level of at least about 1,841 Oxygen Radical Absorbance Capacity (ORAC) per ounce, which is a measure of the total antioxidant capacity of the snack food and/or meal replacements. In some embodiments, the snack food and/or meal replacements may include at least about 1 mg, at least about 2 mg, at least about 3 mg, at least about 5 mg, at least about 10 mg, or at least about 15 mg of vitamin C per ounce. In some embodiments, the snack food and/or meal replacement produce may include at least about 100 IU, at least about 150 IU, at least about 300 IU, at least about 500 IU, at least about 1000 IU, or at least about 1250 IU of vitamin A per ounce. In some embodiments, the snack food and/or meal replacement products may include at least about 0.75 IU, at least about 1.5 IU, at least about 3 IU, or at least about 7.5 IU of vitamin E per ounce. In some embodiments, the snack food and/or meal replacement products may include at least about 1 ug, at least about 1.75 ug, at least about 3 ug, at least about 5 ug, at least about 10 ug, or at least about 15 ug of selenium per ounce. In some embodiments, the snack food and/or meal replacement products may include one or more antioxidants at a level of about 10%; about 20%, about 30% or more of the FDA recommended daily intake value for the one or more antioxidants in a three ounce portion or the equivalent. The vitamin C content of a food item can be determined by a variety of methods, including by HPLC-UV determination (see Fontana et al., 2006, Food Chemistry 94: 626-631). The beta-carotene content of a food item can be determined by a variety of methods, including by HPLC analysis (see Weissenberg et al., 1997, Chromatographia 46 (7/8):399-403).

In some variations, the extruded vegetable-based snack foods, e.g., products, and/or the extruded vegetable-based meal replacements provided herein may include vitamin B-12. In some embodiments, the snack food and/or meal replacements may include at least about 0.3 ug, at least about 0.5 ug, at least about 0.7 ug, at least about 0.9 ug, or at least about 1.1 ug of vitamin B-12 per ounce. In some embodiments, the snack food and/or meal replacements may include vitamin B-12 at a level of about 10%; about 20%, about 30% or more of the FDA recommended daily intake value for vitamin B-12 per three ounce portion of the snack food and/or meal replacement. The vitamin B content of a food item can be determined by a variety of methods, including by reversed-phase liquid chromatography (see Vinas et al., 2003, Journal of Chromatography A 1007: 77-84). B12 may be obtained from Hydrilla or may be synthesized (Methylcobalamin).

In some variations, the extruded vegetable-based snack foods, e.g., products, and/or the extruded vegetable-based meal replacements provided herein may include iron. In some such embodiments, the snack foods and/or the meal replacement products may include at least about 0.2 mg, at least about 0.4 mg, at least about 0.6 mg, at least about 0.8 mg, or at least about 1 mg of iron per ounce. In some embodiments, the snack foods and/or the meal replacement products may include iron at a level of between about 10%; about 20%, about 30% or more of the FDA recommended daily intake value for iron per three ounce portion. Iron content of a food product can be determined by a variety of methods, including but not limited to AOAC International reference method AOAC 965.17/985.01mod. Iron may be obtained from ferrous gluconate for use in these compositions.

In some variations, the extruded vegetable-based snack foods, e.g., products, and/or the extruded vegetable-based meal replacements provided herein may include calcium. In some such embodiments, the snack foods and/or meal replacement products may include at least about 10 mg, at least about 20 mg, at least about 30 mg, at least about 40 mg, or at least about 50 mg of calcium per ounce. In some embodiments, the nutrient-dense meat structured protein products comprise calcium at a level of between about 10%; about 20%; about 30% or more of the FDA recommended daily intake value for calcium per three ounce portion. Calcium content of a food product can be determined by a variety of methods, including but not limited to AOAC International reference method AOAC 965.17/985.01 mod. Calcium may be obtained from Red Algae or Hydrilla for use in these compositions, or may be extracted.

In some variations, the extruded vegetable-based snack foods, e.g., products, and/or the extruded vegetable-based meal replacements provided herein may include omega-3 fatty acids. The snack foods and/or meal replacement products may include at least about 0.1 g, at least about 0.2 g, at least about 0.3 g, at least about 0.4 g, or at least about 0.5 g of omega-3 fatty acids per ounce. In some embodiments, the snack foods and/or meal replacement products may include omega-3 fatty acids at a level of between about 10%; about 20%; about 30% or more of the FDA recommended daily intake value for omega-3 fatty acids per three ounce portion. Omega-3 fatty acid content of a food product can be determined by a variety of methods, including but not limited to AOAC International reference method AOAC Ce 1b-89. In some embodiments, the omega-3 fatty acids may be non-animal derived omega-3 fatty acids. For example, flaxseed oil or docosohexaenoic acid (DHA) oil from Algae may be used.

In some variations, commercially available mixtures of nutrients may be include in the nutrient compositions. Two examples include Grand Fusion 6 Vegetable Blend (manufactured by Nutrifusion), which includes Vitamin A, Vitamin B, Vitamin C, Vitamin D, Vitamin E (this product is an all-natural blend of extracted, encapsulated vitamins. The vitamins are heat resistant); and Grand Fusion 21 Vegetable Blend (manufactured by Nutrifusion) , including Vitamin A, Vitamin B, Vitamin C, Vitamin D, Vitamin E, Vitamin B12, Iron and other minerals (this product is an all-natural blend of extracted, encapsulated vitamins and minerals. The vitamins and minerals are heat resistant).

Antioxidants, In some variations, the extruded vegetable-based snack foods, e.g., products, and/or the extruded vegetable-based meal replacements provided herein may include antioxidants in addition to vitamins included in a nutrient composition incorporated into the products described herein. Antioxidants are compounds that interact with and neutralize free radicals. The antioxidants may be natural or synthetic antioxidants. Examples of antioxidants include but are not limited to carotenes, ubiquinone, resveratrol, alpha-tocopherol, lutein, zeaxanthin, 2,4-(tris-3′,5′-bitert-butyl-4′-hydroxybenzyl)-mesitylene (i.e., Ionox 330), 2,4,5-trihydroxybutyrophenone, 2,6-di-tert-butyiphenol, 2,6-di-tert-butyl-4-hydroxymethylphenol (i.e., Ionox 100), 3,4-dihydroxybenzoic acid, 5-methoxy tryptamine, 6-ethoxy 1,2-dihydro-2,2,4-trimethylquinoline, acetyl gallate, alpha-carotene, alpha-hydroxybenzyl phosphinic acid, alphaketoglutarate, anoxomer, ascorbic acid and its salts, ascorbyl palmitate, ascorbyl stearate, benzyl isothiocyanate, beta naphthoflavone, beta-apo-carotenoic acid, beta-carotene, beta-carotene, butylated hydroxyanisole (BHA), butylated hydroxytoluene (BHT), caffeic acid, canthaxantin, carnosol, carvacrol, catalase, catechins, chlorogenic acid, citric acid and its salts, clove extract, coffee bean extract, di-stearyl thiodipropionate, dilauryl thiodipropionate, dodecyl gallate, edetic acid, ellagic acid, erythorbic acid, esculetin, esculin, ethyl gallate, ethyl maltol, ethylenediaminetetraacetic acid (EDTA), eucalyptus extract, eugenol, ferulic acid, flavanones, flavones, flavonoids, flavonoids, flavonols, fraxetin, fumaric acid, gallic acid, gentian extract, gluconic acid, glycine, gum guaiacum, hesperetin, hydroquinone, hydroxycinammic acid, hydroxyglutaric acid, hydroxytryrosol, hydroxyurea, isflavones, lactic acid and its salts, lecithin, lecithin citrate; R-alpha-lipoic acid, lutein, lycopene, malic acid, maltol, methyl gallate, mono isopropyl citrate, monoglyceride citrate, morin, N-acetylcysteine, N-hydroxysuccinic acid, N,N′diphenyl p-phenylenediamine (DPPD), natural antioxidants, nordihydroguaiaretic acid (NDGA), octyl gallate, oxalic acid, p-coumaric acid, palmityl citrate, phenothiazine, phosphates, phosphatidylcholine, phosphoric acid, phytic acid, phytylubichromel, pimento extract, polyphosphates, propyl gallate, quercetin, retinyl palmitate, rice bran extract, rosemary extract, rosmarinic acid, sage extract, sesamol, silymarin, sinapic acid, sodium erythorbate, stearyl citrate, succinic acid, superoxide dismutase (SOD), synthetic antioxidantss, syringic acid, tartaric acid, taurine, tertiary butyl hydroquinone (TBHO), thiodipropionic acid, thymol, tocopherols, tocotrienols, trans resveratrol, trihydroxy butyrophenone, tryptamine, tyramine, tyrosol, ubiquinone, uric acid, vanillic acid, vitamin K and derivates, wheat germ oil, and zeaxanthin.

Other Ingredients. The extruded vegetable-based snack foods, e.g., products, and/or the extruded vegetable-based meal replacements provided herein may include various other ingredients. In most embodiments, the snack food and/or meal replacements may include any one of these other ingredients at about 0.01%; about 1%; about 2%; about 4%, or about 5%, by weight.

Examples of such ingredients include antimicrobial agents (e.g., potassium sorbate), antiparasitic agents (e.g., avermectins), buffering agents (e.g., citrate), clotting agents (e.g., thromboxane), coagulants (e.g., fumarate), coenzymes (e.g., coenzyme A, coenzyme C, s-adnosyl-methionine, vitamin derivatives), dairy protein (e.g., casein, whey protein), dietary minerals (e.g., ammonium, fat soluble minerals, gypsum, magnesium, potassium, aluminum), disaccharides (e.g., lactose, maltose, trehalose), edulcorants (e.g., artificial sweeteners, corn sweeteners, sugars), egg protein (e.g., ovalbumin, ovoglobulin, ovomucin, ovomucoid, ovotransferrin, ovovitella, ovovitellin, albumin globulin, vitellin), elasticizing agents (e.g., gluten), emulsifiers (e.g., lecithin, lecithins), enzymes (e.g., hydrolase, oxidoreductase, peroxidase), other essential nutrients (e.g., alpha-linolenic acid, gamma-linolenic acid, linoleic acid, zinc), fat soluble compounds, flavones (e.g., apigenin, chrysin, luteolin, flavonols, daemfero, datiscetin, myricetin), glycoproteins, gums (e.g., carob bean gum, guar gum, tragacanth gum, xanthan gum), hemoproteins (e.g., hemoglobin, leghemoglobin, myoglobin), humectants (e.g., polyethylene glycol, propylene glycol, sorbitol, xylitol), isoprenes, isoprenoid pathway compounds (e.g., mevalonic acid, dimethylallyl pyrophosphate, isopentenyl pyrophosphate), isoprenoids or isoprenoid derivatives (e.g., dolichols, polyprenols), liver X receptor (LXR) agonists and antagonists, meat proteins (e.g., collagen), mechanically separated meat, metabolic pathway intermediates (e.g., oxaloacetate, succinyl-CoA), monosaccharides (e.g., fructose, galactose, glucose, lactose, lyxose, maltose, manose, ribose, ribulose, xylulose), neuroactive compounds (e.g., anandamide, cannabinoids, cortisol, endocannabinoids, gamma-aminobutyric acid, inositol), neutraceuticals, nutritional supplements (e.g., carnitine, fumarate, glucosamine), oilsoluble compounds, plasticizing materials, polyols (e.g., alklyne glycols, butanediols, glycerine, glycerol, glycerol, mannitol, propylene glycol, sorbitol, xylitol), polysaccharides (e.g., pectin, maltodextrin, glycogen, inulin), porphyrins, secondary metabolites (e.g., polyketides), secosteroids, spices, steroids (e.g., C18-carbon containing steroids, C19-carbon containing steroids, C21-carbon containing steroids, cholesterol, cycloartenol, estradiol, lanosterol, squalene), sterols (e.g., betasitosterol, brassicasterol, cholesterol, ergosterol, lanosterol, oxysterols, phytosterols, stigmasterol), tannins (e.g., ellagic tannins, ellagic tannins from roasted oak wood, gallic tannins, proanthocyanidin tannins from aromatic grape skin, proanthocyanidin tannins from grape seeds, proanthocyanidin tannins from grape skin, profisetinidin tannins, tannins from green tea leaves, tannins from sangre de drago), terpenes (e.g., diterpenes, monoterpenes, sesquiterpene, squalane, tetraterpenes, triterpenes), thickening agents (e.g., guar gum, pectin, xantham gum, agar, alginic acid and its salts, carboxymethyl cellulose, carrageenan and its salts, gums, modified starches, pectins, processed Eucheuma seaweed, sodium carboxymethyl cellulose, tara gum), other vitamins (e.g., alpha-tocopherol, alpha-tocotrienol, beta-tocopherol, beta-tocotrienol, deltatocopherol, delta-tocotrienols, fat soluble vitamins, gamma-tocopherol, gamma-tocotrienol, pantothenic acid, vitamin A, vitamin E, vitamin K, water soluble vitamins), water-soluble compounds, wax esters, and xenoestrogens (e.g., phytoestrogens).

Coloring Agents. Further examples of ingredients which may be added in very small quantities, e.g., other ingredients, include but are not limited to coloring agents (e.g., FD&C (Food Drug & cosmetics) Red Nos. 14 (erythrosine), FD&C Red Nos. 17 (allura red), FD&C Red Nos. 3 (carmosine), FD&C Red Nos. 4 (fast red E), FD&C Red Nos. 40 (allura red AC), FD&C Red Nos. 7 (ponceau 4R), FD&C Red Nos. 9 (amaranth), FD&C Yellow Nos. 13 (quinoline yellow), FD&C Yellow Nos. 5 (tartazine), FD&C Yellow Nos. 6 (sunset yellow), artificial colorants, natural colorants, titanium oxide, annatto, anthocyanins, beet juice, beta-APE 8 carotenal, beta-carotene, black currant, burnt sugar, canthaxanthin, caramel, carmine/carminic acid, cochineal extract, curcumin, lutein, mixed carotenoids, monascus, paprika, red cabbage juice, riboflavin, saffron, titanium dioxide, turmeric).

Methods. Methods of producing an extruded vegetable-based food product, and/or an extruded vegetable-based replacement meal are provided including: combining a solid vegetable composition comprising a leguminous protein isolate; leguminous grits and rice grains with water to form a dough. The solid vegetable composition may be composed as any solid vegetable composition described above. In some variations, the solid vegetable composition includes a yellow pea isolate, yellow pea grits and coarsely ground white rice. In some variations, the ratio of the solid vegetable composition to the water in the dough is from about 80:20; about 81:19; about 82:18; about 83:17; about 84:15; about 85:15 or any range of ratios therebetween to provide a superior aerated extruded product.

The dough is extruded under heat to form an extruded vegetable-based aerated bite-sized form. The extrusion may be performed using a single-screw extruder or double-screw extruder and may employ a variety of dies to produce a variety of extruded shapes. The extruded vegetable-based aerated bite-sized form may be a crisp, a puff, a “noodle”, a shape mimicking a piece of a meat product, a sphere, an irregular polygonal shape. In producing any particular shape, the extruded vegetable-based aerated bite-sized form may be very uniform or may be produced to create varying versions of the basis form, such as smaller fragments or unevenly bent shapes.

Extrusion may be effected under elevated heat, which may be a temperature of about 100 degrees F., about 150 degrees F., about 200 degrees F., about 250 degrees F., about 300 degrees F., about 310 degrees F., about 320 degrees F., about 325 degrees F., about 330 degrees F., about 335 degrees F., about 340 degrees, about 350 degrees F., or any range of temperatures therebetween. The extruded vegetable-based aerated bite-sized form, just after extrusion, has a density of between about 50 g/L to about 90 g/L (e.g., between about 50 g/L and 85 g/L, etc.). The extruded vegetable-based aerated bite-sized form is then dried, whereby the dried extruded vegetable-based aerated bite-sized form comprises less than 2% water content. In some variations, the dried extruded vegetable-based aerated bite-sized form may contain from about 0.5% moisture, i.e., water, to about 1.5% moisture.

The dried extruded vegetable-based aerated form is then tumbled to produce the extruded vegetable-based food product having a density from about 50 g/L to about 90 g/L, about 55 g/L to about 90 g/L, about 60 g/L to about 90 g/L, about 65 g/L to about 90 g/L, about 70 g/L to about 90 g/L, about 75 g/L to about 90 g/L, about 50 g/L to about 85 g/L, about 55 g/L to about 85 g/L, etc., or any range of values of density therebetween. The density may alternatively be stated in terms of milligrams/cubic centimeters, i.e., from about 50 mg/cc, about 55 mg/ccL, about 60 mg/cc, about 65 mg/cc, about 70 mg/cc, about 75 mg/cc, about 80 mg/cc, etc. to about 90 mg/cc, about 85 mg/cc, etc., or any range of values of density therebetween. Tumbling may further include applying a vegetable-based oil to the dried extruded vegetable-based aerated form before tumbling the dried extruded vegetable-based aerated form, e.g., as the dried extruded vegetable-based aerated form is added into the tumbler. The vegetable oil may be any vegetable oil as mentioned above, and in some variations may be a vegetable oil having a substantially neutral flavor such as safflower, canola, sunflower or grape seed oil. Tumbling may also include applying flavorings to the dried extruded vegetable-based aerated form after tumbling or towards the end of the tumbling process. The flavorings may be vegetable-based flavors, and may be savory, spiced, salty, or sweet. In some variations, the flavorings produce a flavor imitating a meat product.

The extruded vegetable-based food product, e.g. snack, or extruded vegetable-based replacement meal product, is light compared to its volume, and has a density from about 50 g/L, about 55 g/L, about 60 g/L, about 65 g/L, about 70 g/L, about 75 g/L, or about 80 g/L, to about 90 g/L, about 85 g/L, etc., or any range of values of density therebetween. The density may alternatively be stated in terms of milligrams/cubic centimeters, i.e., from about 50 mg/cc, about 55 mg/ccL, about 60 mg/cc, about 65 mg/cc, about 70 mg/cc, about 75 mg/cc, etc., to about 90 mg/cc, about 86 mg/cc, etc., or any range of values of density therebetween. The solid vegetable composition of the snack food or meal replacement product may form from about 60% w/w, about 62% w/w, about 64% w/w, about 66% w/w, about 68% w/w, about 70% w/w, about 72% w/w, about 74% w/w, about 76% w/w, about 78% w/w, about 80% w/w, about 82% w/w, or any range of values of the solid vegetable composition content therebetween of the extruded vegetable-based food product and/or extruded vegetable-based meal replacement. The vegetable oil may form from about 12% w/w, about 13% w/w, about 14% w/w, about 15% w/w, about 16% w/w, about 17% w/w, about 18% w/w, about 19% w/w, about 20% w/w, or any range of values of the vegetable oil content therebetween of the extruded vegetable-based food product and/or extruded vegetable-based meal replacement. The flavorings may form from about 5% w/w, about 6% w/w, about 7% w/w, about 8% w/w, about 9% w/w, about 10% w/w, about 11% w/w, etc., to about 15% w/w, about 14% w/w, etc., or any range of values of the vegetable oil content therebetween of the extruded vegetable-based food product and/or extruded vegetable-based meal replacement. The water content of the extruded vegetable-based food product and/or extruded vegetable-based meal replacement may be from about 0.5% w/w to about 1.5% w/w.

In some variations, an extruded vegetable-based food product is produced by the method, and the ratios of the components of the solid vegetable composition are varied in the dry mix used to make the dough such that the extruded vegetable-based food product comprises at least 7 g protein per ounce, thereby providing an extruded vegetable-based meal replacement. In some variations, the dough for manufacturing an extruded vegetable-based food product may further include a nutrient composition, wherein the nutrient composition comprises vitamins and minerals. In some variations, the nutrient composition may be added to the dry mix used to form the dough. If the desired nutrients include omega-3 fatty acids, those ingredients will be added later in the process to avoid exposure to heat during extrusion. The nutrient composition may include any of the nutrient compositions described above in any combination. In some variations, the quantity of the nutrient composition added to the dry mix, or otherwise introduced into the meal replacement product may include 25-30% of a daily recommended amount per three ounce portion of the extruded vegetable-based meal replacement.

In some variations, tumbling further comprises applying omega-3 fatty acids, as part of the oils applied to the dried extruded vegetable-based aerated form. The omega-3 fatty acids may be any as described above.

In some variations, one or more ingredient of the nutrients becomes degraded during the extrusion process, such ingredient may be applied topically along with the flavoring in the post-extrusion processing.

Packaging and Labeling. The extruded vegetable-based snack foods, e.g., products, and/or the extruded vegetable-based meal replacements provided herein may be packaged to keep the snack food and/or meal replacementst clean, fresh, contained, or safe; to facilitate inventory control, handling, distribution, stacking, display, sale, opening, reclosing, use, or reuse; or to enable portion control. Suitable packing includes but is not limited to trays, trays with overwrap, bags, cups, films, jars, tubs, bottles, pads, bowls, platters, boxes, cans, cartons, pallets, wrappers, containers, bags-in-boxes, tubes, capsules, vacuum packaging, pouches, and the like, and combinations thereof. The packaging can be made of plastic, paper, metal, glass, paperboard, polypropylene, PET, Styrofoam, aluminum, or combinations thereof.

The packaging may carry one or more labels that communicate information to the consumer or that support the marketing of the extruded vegetable-based snack foods, e.g., products, and/or the extruded vegetable-based meal replacements. In some embodiments, the packaging carries a label required by governmental regulation. In some such embodiments, the label is required by regulation of the U.S. Food and Drug Administration (FDA) or the U.S. Department of Agriculture. In other such embodiments, the label is required by regulation of the European Food Safety Authority. In some embodiments, the governmental regulation is Title 21 of the FDA section of the code of federal regulations. In some embodiments, the label indicates that the enclosed extruded vegetable-based snack foods, e.g., products, and/or the extruded vegetable-based meal replacements are free of genetically modified organisms. In some embodiments, the label indicates that the enclosed extruded vegetable-based snack foods, e.g., products, and/or the extruded vegetable-based meal replacements are free of gluten. In some embodiments, the label indicates that the enclosed extruded vegetable-based snack foods, e.g., products, and/or the extruded vegetable-based meal replacements are Kosher. In some embodiments, the label indicates that the enclosed extruded vegetable-based snack foods, e.g., products, and/or the extruded vegetable-based meal replacements are free of cholesterol. In some embodiments, the label indicates that the enclosed extruded vegetable-based snack foods, e.g., products, and/or the extruded vegetable-based meal replacements are vegan. In some embodiments, the label indicates that the enclosed extruded vegetable-based snack foods, e.g., products, and/or the extruded vegetable-based meal replacements are free of an allergen. In some embodiments, the label indicates that the enclosed extruded vegetable-based snack foods, e.g., products, and/or the extruded vegetable-based meal replacements are free of soy. In some embodiments, the label indicates that the enclosed extruded vegetable-based snack foods, e.g., products, and/or the extruded vegetable-based meal replacements are free of nuts.

### EXAMPLES

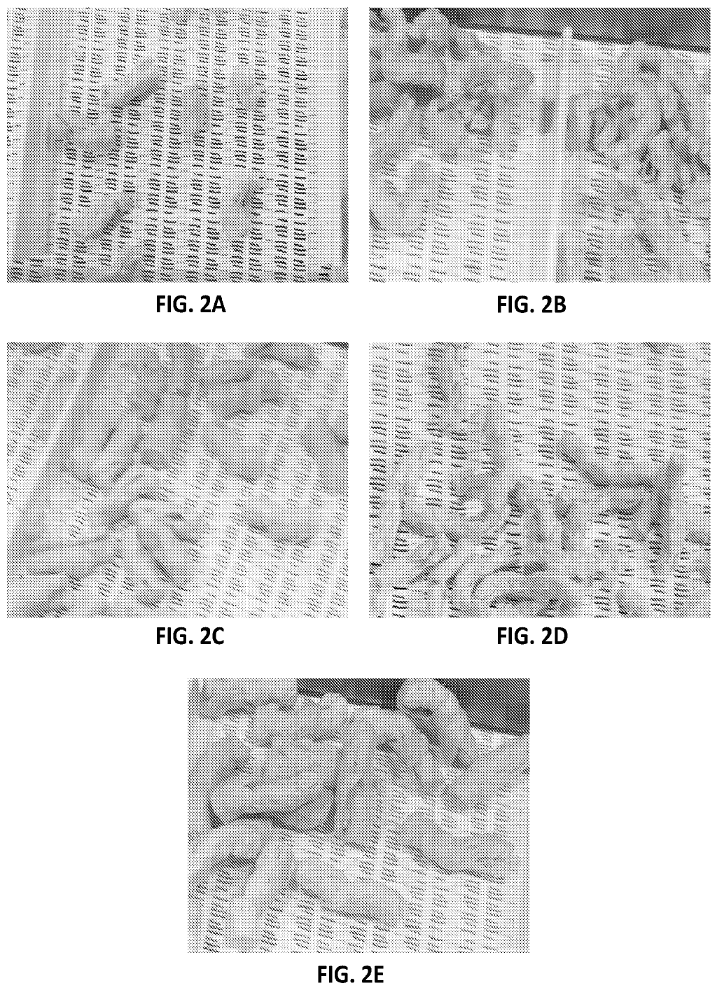

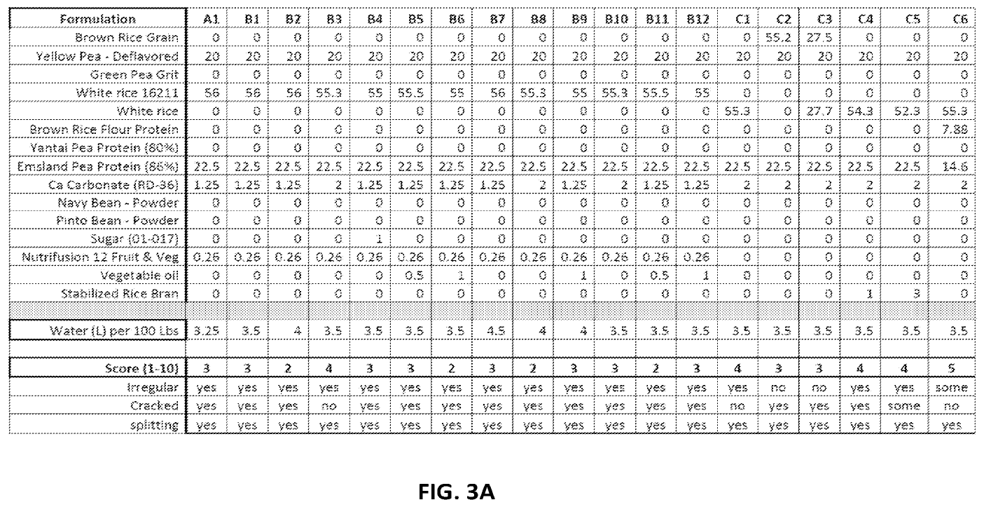

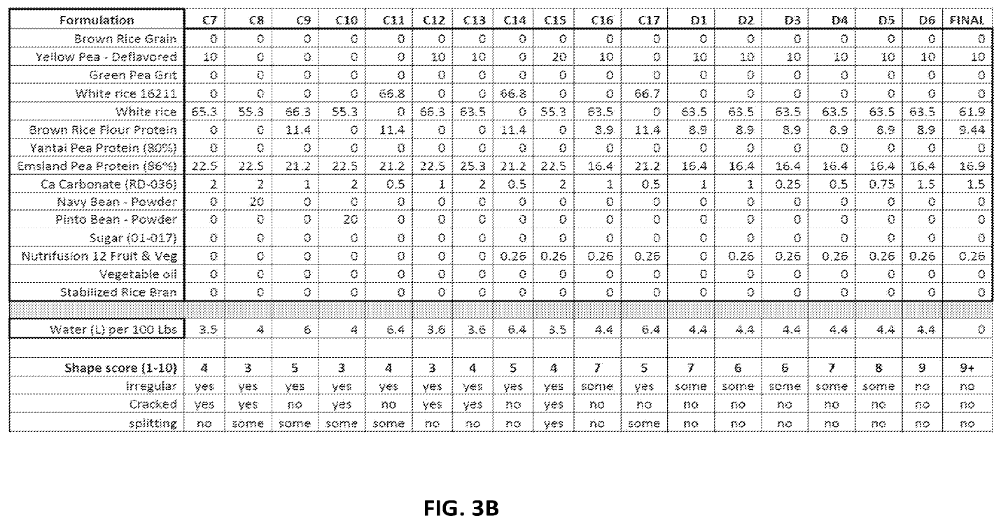

The high-protein puffed meal-replacement compositions described herein were developed to have a particular surface an internal texture and uniformity of shape. It was surprisingly found that the initial composition, and in particular, the composition of the flour and grain components contributing to the high protein levels, was important in permitting extrusion of the mixture in a uniform manner. As discussed above, FIG. 1 illustrates an example of a puffed vegetable-based meal replacement food that was successfully formed as described below. FIGS. 2A-2E illustrate examples of unsuccessful puffed vegetable-based meal replacement compositions, and FIGS. 3A-3B illustrate examples of material that is alternative formulations that have been scored as described in detail below. These examples illustrate that, in order to achieve an extruded, vegetable-based high protein meal replacement foodstuff having desirable surface texture, uniformity and density, it is necessary to use brown rice protein (e.g., brown rice protein flour) within a specific percentage range. Further, limiting the amount of leguminous grits to between 1%-15%, in combination with the brown rice flour is also important. Finally, the use of calcium carbonate within a specific range also allowed more uniform extrusion. Outside of the specified ranges, the resulting puffed product is irregular, has a rough surface texture and may include cracks and splitting.

As shown in the table of FIGS. 2A-2B, each column (A1—Final) illustrates an example of a formulation that was manufactured and scored. Scoring was done on a 1-10 numeric scale, with 1 being poorly extruded, including highly irregular shapes, cracking (transverse to the elongate cylindrical length) and splitting (along the longitudinal length). The density was also examined. The formulations varied components as well as the amount (by percent of the original mixture). The bottom four rows of the table show the overall shape score (from 1-10) as well as an indication of regularity of the dimensions (diameter, length, shape), cracking and splitting. The formulation components listed include brown rice grain, yellow pea flour (deflavored), green pea grit, white rice (first type), white rice (second type—16211), brown rice flour protein, pea protein (Yantai, 80%), pea protein (Emsland, 86%), calcium carbonate (RD-036), navy bean powder, pinto bean powder, sugar, encapsulated vitamin blend (Nutrifusion 12 Fruit & Veg), vegetable oil, and stabilized rice bran. The values in the columns corresponding to these rows represent percentages of the mixture that was extruded. The extruded product was examined and scored.

For example, formulation “B1” is shown in FIG. 2A. In this example, the extruded puffs, which having the requisite level of protein (>7 g per ounce serving) of vegetable-based protein, were misshaped, had a rough surface texture and were erratically sized and shaped (non-standard sized). Visible and deep cracking and splitting may be seen. The overall score (body score) was 2. FIG. 2B shows a similar result with formulation B6. These compositions included yellow pea extract (20%), white rice (55-56%), Emsland pea protein (22.5%), calcium carbonate (1.25%), and encapsulated vitamins (0.26%). As shown in the table, various parameters were modified, including the type of vegetable protein and the percentages of these components. FIG. 2C shows puffs formed using C2, showing somewhat more regular dimensions, but smaller than desired and with a high level of cracking and splitting. This example shows the use of broad rice grain, which (unlike brown rice flour protein) did not improve the morphology or density of the resulting puff. Similar results were seen with other formulations, including C15. Surprisingly, after the substitution of brown rice flower, as shown in formulations C6, C9, C11, C14 and C16-D6 that the extrusion morphology improved significantly. In addition, reducing the amount of yellow pea flower in half concurrently with the use of brown rice flour resulted in a significant increase in scores for puff body morphology, reducing cracking and splitting. Finally, as shown in formulation D1-D6, tuning of the amount of calcium carbonate in the extrusion mixture resulted in regular and successful puffs.

Thus, the composition of the extruded puffs described herein result in a puffed composition that is substantially free of cracks and has an even surface texture.

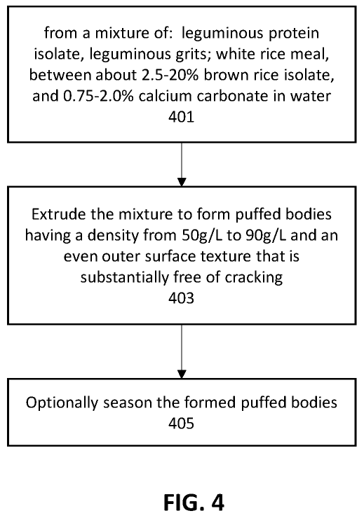

FIG. 4 illustrates one method of manufacturing a vegetable-based meal replacement composition having this successful formulation. For example in FIG. 4, the method may first include forming a mixture of: leguminous protein isolate (e.g., 10%-25%), leguminous grits (e.g., yellow pea flour, 5%-20%), white rice meal (e.g., 50-75%), brown rice isolate (e.g., 2.5-20%), calcium carbonate (e.g., 0.75%-2.0%) and water 401. This mixture may then be extruded 403, to form a plurality of puffed bodies having a density from 50 g/L to 90 g/L and an even outer surface texture that is substantially free of cracking. The extruded vegetable-based meal replacement composition with have at least 7 g protein per ounce. Optionally, the puffs may be seasoned (e.g., with vegetable oil and vegetable-based seasonings) 405.

Examples of these techniques are provided below.

Experiment 1. A dry mix was made including 57.5% White Rice Meal, 20% Yellow Pea Flour (Grits) and 22.25% Pea Protein Isolate. The white rice meal was coarsely ground, typically stone-ground, and is not as fine as rice flour. Yellow pea grits was obtained as a coarsely ground flour or meal, typically stone-ground, of yellow peas. Pea protein isolate is available commercially from sources such as Bob's Red Mill or Puris foods. Pea protein isolate was produced by aqueous dissolution from peas. The pea grits and white rice meal were ground as the raw starting materials. The dry mix was hydrated with about 16% water, but percentages as low as 15% water and as high as 20% were used successfully.

The resulting dough was extruded through a single screw snack extruder. The extruder was set at a temperature of 325 degrees F., and the spindle speed was set at 90 rpm. Any of the temperature, extruder type, and spindle speed may be varied to produce differently textured or shaped food product. Different dies may be used to change the shape of the food product. The snack food was shaped as a “pork rind” which provides expanded rectangles or portions of rectangles thereof, and also includes bends and twists to provide a varied population of extruded, aerated snack food shapes. The snack food is extruded to be “bite-sized”, e.g., having a size where an individual extruded snack food form can be bitten off and eaten in one or two actions. The extruded snack food form contained a substantial amount of encapsulated air, with the newly extruded snack food form having a highly variable density; optimally, the range would be between 50 g/L and 90 g/L (e.g., about 53 g/L to about 85 g/L). This example is not a high-protein meal replacement composition but is an alternative snack food that uses many of the same process techniques.

While some of the moisture used to create the dough evaporated, the extruded snack form was then dried in an oven to provide a dried aerated snack food form. The density was variable. A target density would be between about 55 g/L to 75 g/L, with a final water content of about 0.5% to about 2.0% w/w.

Additional processing may be used to provide to provide more randomized shapes to the dried aerated snack food form, and the dried extruded snack food forms were tumbled. At the ingress to the tumbler, sunflower oil was sprayed onto the extruded “rind” shaped snacks. At the egress from the tumbler, seasoning blends of spices and other flavorings were added to the tumbled snack form, in this case, savory flavorings including salt, were applied. The final mixture created may include about 73% w/w extruded “rind” shaped snack food forms, 18.2% w/w sunflower oil, and 8.8% w/w seasonings blend.

Finally, the product extruded vegetable-based snack food having pieces shaped like pieces of a pork rind may be transported, e.g., via a conveyor belt, to a bagging machine, where the snack food may be portioned and bagged.

Experiment 2: Meal replacement puff. A meal replacement puff is prepared using similar steps as described in Experiment 1 for the snack food. As an initial experiment, the dough is prepared by mixing White Rice Meal, Yellow Pea Grits and Pea Protein Isolate, roughly in a 5:2:2 ratio, using materials similar to those used above. The ratio is varied to increase the last two components Yellow Pea Grits and Pea Protein Isolate such that the dry mix contains at least 7 g total protein/ounce of meal replacement puff. The dry mix further includes a nutrient composition including vitamins and minerals, where the vitamins include Vitamin A,

Vitamin B6 and/or B12, Vitamin C, Vitamin D, Vitamin E, and Vitamin K. The amounts required for a meal replacement providing approximately 30% of the daily requirements are very small, since most vitamins require hundreds of IU or milligrams or micrograms per day, and do not change the overall weight percentage of the dry mix. The required daily amount of minerals Calcium and Iron range from tens of milligrams for Iron to 1 gm/day for Calcium, and likewise do not appreciably change the composition percentages of the dry mix. The dry mix was hydrated with about 16% water.

Extrusion is performed similarly to the extrusion process in Experiment 1, but a different die may be used to provide a different shape, such as, for example, a cheese “noodle” or “curl”, with subsequent drying as described above to provide an aerated dried meal replacement form having from 0.5% to 2.0% water content.

Tumbling is performed as before, but only to coat the dried extruded meal replacement form with sunflower oil as described above, and not to randomize the shape of the dried extruded replacement meal form. The proportion of sunflower oil is as above but an addition may optionally be made to the oil to include omega-3 fatty acids. The omega-3 fatty acids are provided by flaxseed oil and/or docosohexaenoic acid (DHA). Seasonings are added as described in Experiment 1, and are savory, providing a sensory impression of cheese. The seasoned and oil coated tumbled extruded vegetable-based meal replacement pieces are transported and bagged in a three-ounce quantity suitably providing protein and nutrients equivalent to FDA recommended values for one meal.

Initial experiments using just White Rice Meal, Yellow Pea Grits and Pea Protein Isolate, such as those above, when including calcium carbonate and an encapsulated vitamin blend (such as GrandFusion Vitamin Blend, NutriFusion, Hilton Head S.C.), formulated to have greater than 6 g of protein per oz serving resulted in a highly dense (e.g., >90 g/L, >100 g/L, etc.) product. Densities of greater than 90% are not desirable for a puffed snack product.

The inventors have found that the resulting density of the puffed product may be adjusted to the desired (e.g., 90% or less) range by including brown rice protein isolate, in addition to white rice meal, yellow pea flour (grits) and pea protein extract, within a defined range (e.g., between about 2.5% and 20%). Surprisingly, in high-protein extrusion formulations such as those described herein, when the percentage of white rice meal (e.g., between 30-45%), yellow pea flour (between 4-10%) and peal protein isolate (between 8-15%) was used, only those formulations including brown rice protein isolate (e.g., between 2.5% and 20%) successfully puffed (as described above) and resulted in a density of the puffed product of 90% or less, particularly when combined with an encapsulated vitamin mixture. Pea proteins isolate alone, or brown rick protein isolate alone, or combinations of pea protein isolate and other vegetable protein isolates resulted in densities of the puffed product that were greater than 90 g/L (e.g., greater than 100 g/L), particularly when an encapsulated vitamin mixture was used.

In any of these examples, a vitamin mixture (e.g., including all or some of: Vitamin A, Vitamin B6, Vitamin B12, Vitamin C, Vitamin D, Vitamin E, Vitamin K, Thiamin, Riboflavin, Niacin, Calcium, Iron, Iodine, Zinc, Selenium, Copper, Manganese, Chromium, Molybdenum) may preferably be encapsulated in a food-grade material, such as carbohydrate polymers (e.g., starches, cellulose, gum Arabic, gum karaya, mesquite gum, galactomannans, soluble soybean, polysaccharides, gluten, caseins, etc.). Preferably the percentage of encapsulated vitamin mix may be less than 0.5% (e.g., less than 0.4%, 0.3%, 0.2%, etc., between 0.5%-0.1%, etc.). Calcium carbonate may be included in the formulation (e.g., between about 0.75% and about 2%, e.g., between 1%-3%, etc.).

In any of the formulations described herein Omea-3 oil may be excluded.

### Example 2: Meal Replacement Puff

A meal replacement puff was prepared using similar steps as described above for the snack food. As an initial experiment, the dough formulation was prepared by mixing White Rice Meal, Yellow Pea Grits and Pea Protein Isolate and brown rice protein isolate within the percentage ranges described below. In addition, an encapsulated vegetable-sourced vitamin mixture (e.g., GrandFusion Vitamin Blend) and Calcium Carbonate were combined. The amount of yellow pea grits, pea protein isolate, and brown rice protein isolate was varied within the ranges described below so that the dry mix contained at least 7 g of total protein/ounce of the meal replacement puff. Table 1 below shows ranges of components that were formulated to be extruded as described herein.

TABLE 1

| Extrusion | | Final | | |
|---|---|---|---|---|
| Formulation (w/w/) | | Product (w/w) | | |
| Example | Range | Example | Range | Component |
| 61.9% | 50%-75% | 42.1% | 35%-50% | White Rice Meal |
| 10% | 5%-20% | 6.8% | 4%-10% | Yellow Pea Flower |
| | | | | (Grits) |
| 16.9% | 10%-25% | 11.5% | 8%-15% | Pea Protein Isolate |
| 9.44% | 2.5%-20% | 6.4% | 2%-13% | Brown Rice Protein |
| | | | | Isolate |
| 0.26% | 0.1%-l% | 0.18% | 0.06%-0.5% | Vitamin Blend |
| 1.5 | 0.75-2.0% | 1.0% | 0.5%-1.5% | Calcium Carbonate |
| | | 20.0% | 10%-30% | Optional (Seasoning) |
| | | | | Organic high oleic |
| | | | | Sunflower Oil |
| | | 12.0% | 6%-18% | Optional (Seasoning) |
| | | | | Organic Tomato & |
| | | | | Basil dry powder |

The amount of encapsulated vitamin blend was adjusted so that the meal replacement puff included approximately 30% of the daily requirements for Vitamin A, Vitamin B6, Vitamin B12, Vitamin C, Vitamin D, Vitamin E, Vitamin K, Thiamin, Riboflavin, Niacin, Iron, Iodine, Zinc, Selenium, Copper, Manganese, Chromium, Molybdenum. The required amount Calcium was adjusted by adjusting the amount of calcium carbonate used. The dry mix was hydrated with water.

Extrusion was performed similarly to the extrusion process described above, using a single-screw extruder. The die may be used to provide a “noodle” or “curl” shape, with subsequent drying as described above to provide an aerated dried meal replacement form having from 0.5% to 2.0% water content. Tumbling may be performed as before, but only to coat the dried extruded meal replacement form with sunflower oil as described above, and seasoning was added. The final formulation resulted in a puffed product having: 42.80% White Rice Meal, 6.80% Yellow Pea Flour (Grits), 11.15% Pea Protein Isolate, 6.05% Brown Rice Protein Isolate, 0.18% GrandFusion Vitamin Blend, 1.02% Calcium Carbonate, 20.00% Sunflower Oil and 12.00% Seasoning. The resulting puff also had a nutritional content, for a single serving of 28 g, of approximately 130 calories, 6 g total fat (0.5 g saturated fat, 0 g trans-fat), 0 mg cholesterol, 200 mg sodium, 12 g total carbohydrate (1 g dietary fiber, 0 g total sugar), and 7 g of protein per ounce.

In one example, the ingredients included rice, expeller-pressed sunflower oil, pea protein, “Vegan Pizza Seasoning” (Pea Protein, Tomato Powder, Sea Salt, Garlic Powder, Spices, Baker's Yeast Extract, Organic Flavor, Olive Oil, Onion Powder, Lactic Acid, Paprika Extract), Yellow Pea, Brown Rice Protein, Calcium Carbonate, and Nutrients from the Vitamin Blend (Broccoli, Spinach, Kale, Pumpkin, Squash, Sweet Potato, Sunflower Seed, Kelp, Chlorella, Maitake Mushroom, Shitake Mushroom). Each serving may also have 2 mcg of Vitamin D, 124 mg of Calcium, 3 mg Iron, 138 mg Potassium, 98 mcg Vitamin A, 10 mg Vitamin C, 4 mg Vitamin E, 14 mcg Vitamin K, 0.1 mg Thiamin, 0.1 mg Riboflavin, 2 mg Niacin, 0.2 mg Vitamin B6, 0.2 mcg Vitamin B12, 15 mcg Iodine, 1 mg Zinc, 6 mcg Selenium, 0.1 mg Copper, 0.3 mg Manganese, 4 mcg Chromium, and 5 mcg Molybdenum.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An extruded vegetable-based meal replacement composition comprising:
a plurality of puffed cylindrical shapes comprising:
8%-15% of a leguminous protein isolate; 4%-10% of a leguminous grits; 35-50% of a white rice meal; 2-13% of a brown rice isolate; 0.5%-1.5% of a calcium carbonate; and an encapsulated vitamin extract;
wherein the puffed cylindrical shapes have a density from 50 g/L to 90 g/L, an even outer surface texture, and further wherein the extruded vegetable-based meal replacement composition comprises at least 7 g protein per ounce.

2. The extruded vegetable-based meal replacement composition of claim 1, wherein the puffed cylindrical shapes are substantially free of cracks.

3. (canceled)

4. The extruded vegetable-based meal replacement composition of claim 1, further comprising vegetable oil and seasonings.

5. The extruded vegetable-based meal replacement composition of claim 4, further comprising a vegetable-based flavoring that is substantially free of animal byproducts.

6. The extruded vegetable-based meal replacement composition of claim 1, wherein the encapsulated vitamin extract comprises one or more of Vitamin A, Vitamin B, Vitamin B12, Vitamin C, Vitamin D, Vitamin K, in any combination.

7. The extruded vegetable-based meal replacement composition of claim 1, wherein the encapsulated vitamin extract comprises an antioxidant vitamin.

8. The extruded vegetable-based meal replacement composition of claim 1, wherein the extruded vegetable-based meal replacement composition comprises 25%-30% of a daily recommended amount per three-ounce portion of the extruded vegetable-based meal replacement composition.

9. The extruded vegetable-based meal replacement composition of claim 1, wherein the puffed cylindrical shape has 0.5% to 1.5% water by weight of the extruded vegetable-based meal replacement composition.

10. The extruded vegetable-based meal replacement composition of claim 1, wherein the leguminous protein isolate comprises 10%-13% w/w of the extruded vegetable-based meal replacement composition.

11. The extruded vegetable-based meal replacement composition of claim 1, wherein the leguminous grits comprises 5%-9% w/w of the extruded vegetable-based meal replacement composition.

12. The extruded vegetable-based meal replacement composition of claim 1, wherein the white rice meal comprises between 37% to 47% w/w of the extruded vegetable-based meal replacement composition.

13. The extruded vegetable-based meal replacement composition of claim 1, wherein the leguminous protein isolate is pea protein isolate.

14. The extruded vegetable-based meal replacement composition of claim 1, wherein the leguminous grits comprises pea grits.

15. An extruded vegetable-based meal replacement composition comprising:
a plurality of puffed bodies having an even outer surface texture, the puffed bodies comprising:
8%-15% of a leguminous protein isolate; 4%-10% of a leguminous grits; 35-50% of a white rice meal; 2-13% of a brown rice isolate; 0.5%-1.5% of a calcium carbonate; and an encapsulated vitamin extract;
wherein the puffed bodies have a density from 50 g/L to 90 g/L, are substantially free of cracks, and further wherein the extruded vegetable-based meal replacement composition comprises at least 7 g protein per ounce.

16.-29. (canceled)

30. A method of manufacturing a vegetable-based meal replacement composition, the method comprising:
forming a mixture of:
10%-25% leguminous protein isolate; 5%-20% leguminous grits; 50-75% white rice meal, 2.5-20% brown rice isolate, 0.75%-2.0% calcium carbonate in water; and
extruding the mixture to form a plurality of puffed bodies having a density from 50 g/L to 90 g/L and an even outer surface texture that is substantially free of cracking,
wherein the extruded vegetable-based meal replacement composition comprises at least 7 g protein per ounce.

31. The method of claim 30, wherein extruding the puffed bodies comprises extruding cylindrical shapes.

32. The method of claim 30, wherein forming the mixture further comprises adding 0.1%-1% of an encapsulated vitamin blend.

33. The method of claim 30, further comprising seasoning the plurality of puffed bodies.

34. The method of claim 30, wherein forming the mixture comprises using between 12-20% of pea protein isolate as the leguminous protein isolate.

35. The method of claim 30, wherein forming the mixture comprises using between 7%-12% of yellow pea flour as the leguminous grits.

36. The method of claim 30, wherein forming the mixture comprises using between 8%-12% of brown rice protein isolate.
